(19) United States
(12) Patent Application Publication
(10) Pub. No.: US 2006/0249486 A1
(43) Pub. Date: Nov. 9, 2006

(54) Laser welding method and laser welding arrangement

(76) Inventor: Peter Rippl, Augsburg (DE)

Correspondence Address: MCGLEW & TUTTLE, PC, P.O. BOX 9227, SCARBOROUGH STATION, SCARBOROUGH, NY, 10510-9227, US

(21) Appl. No.: 10/553,583

(22) PCT Filed: Apr. 28, 2004
(86) PCT No.: PCT/EP04/04463

§ 371 Date: Oct. 17, 2005

(30) Foreign Application Priority Data
Apr. 29, 2003 (DE) 203 06 581.6

(51) Int. Cl. B23K 26/067; B23K 26/24

(52) U.S. Cl. 219/121.63; 219/121.77

(57) ABSTRACT

A machining system and unit, especially a welding cell, is provided for use for the machining of workpieces (2), especially body parts of vehicles. The machining system has one or more machining stations (15, 16) with robots (18, 19, 20) and at least one rotation or turning station (5), which has at least two work stations (6, 7) for carrying out different operations simultaneously. The turning station (5) has at least two multiaxially movable turning units (8, 9) arranged next to one another with the gripping tools (11, 12, 13). The working areas (10) intersect each other at the work stations (6, 7).

### CROSS REFERENCE TO RELATED APPLICATIONS

This application is a United States National Phase application of International Application PCT/EP2004/004463 filed Apr. 28, 2004 and claims the benefit of priority under 35 U.S.C. § 119 of German Application DE 203 06 581.6 filed Apr. 29, 2003, the entire contents of which are incorporated herein by reference.

### FIELD OF THE INVENTION

The present invention pertains to a process for laser welding and to a laser welding device for welding components with one or more laser welding heads.

### BACKGROUND OF THE INVENTION

Such processes and laser welding devices are known from practice. They are used, for example, to weld components of vehicle bodies and comprise one or more laser welding heads. The laser welding heads are moved by robots along the stationary component or workpiece. For example, subassemblies such as the front floor, middle floor and rear floor are manufactured first in the manufacture of bodies, and they are then joined into main assemblies, tacked into a complete vehicle assembly in the geometry station and then welded completely in a final welding line. The components are transported, for example, by shuttle systems or by industrial robots by means of grippers in robot parks during the manufacture of subassemblies. However, the components are held stationarily during the welding operation and are usually also clamped. The laser welding heads can have a short focal length and are moved by the robot in the immediate vicinity and, by means of a clamping roller, in contact with the component. If the laser beam remote technique with spaced-apart lasers and longer focal lengths is used, the laser beam is usually deflected and moved by a monoaxial or multiaxial scanner optical system. The laser welding head may be arranged stationarily or guided by a robot in this case. The laser beam being moved by the scanner optical system usually scans a certain working field, which can be correspondingly enlarged by handling the laser welding head by means of an industrial robot or the like. This will happen either by a shifting movement of the laser welding head by the industrial robot in point-to-point (PTP) operation or by a continuous further movement of the laser welding head by the industrial robot in path operation, in which case the movement of the robot is superimposed to the movement of the scanner mirror. The resulting overall path or weld seam is obtained by the corresponding control and programming of the scanner optical system and the robot movement. Depending on the design of the plant and the manufacturing method, there is a hitherto relatively unfavorable cost and time component between the time component for the transportation of the component and the creation of value on the component or the investment and operating costs that are necessary therefor and resulting therefrom.

### SUMMARY OF THE INVENTION

The object of the present invention is to provide an improved laser welding device.

According to the invention, a laser welding device is provided for welding one or more components. The device has one or more laser welding heads. The laser welding device has one or more moving means for the components for a relative movement in relation to the laser welding head. The laser welding head is designed as a remote laser and is arranged at a spaced location from the component.

According to another aspect of the invention, a process for the laser welding is provided for one or more components. One or more laser welding heads are employed with the components being guided and moved during welding by one or more moving means with a preferably multiaxial relative movement in relation to the laser welding head. The laser welding head is designed as a remote laser and is arranged at a spaced location from the component.

Due to the use of a controlled component handling during the welding operation in conjunction with the laser remote technique during laser beam welding, cost-optimized plant designs can be developed. These can be improved even further when a time-optimized assignment of the laser beam source or the laser beam takes place, which can be brought about, for example, by beam switches. The time component for the transportation of the component with simultaneous creation of value at the component can be optimally utilized now by corresponding control and regulation operations. The movement of the component and the movement of the laser beam are superimposed now to one another, and this leads to an optimal welding movement in the resulting movement process. The laser welding head may be arranged stationarily or in a mobile manner.

The handling of the component by means of a suitable moving means, preferably a multiaxial industrial robot or articulated arm robot, can also be compensated and adjusted the focal distance by the movement of the component. Such an optimized guiding of the focal distance makes it possible, on the one hand, to use remote lasers with a shorter focal length of, e.g., 250 mm. Focal lengths of 1 m and more have currently been necessary in remote lasers because of the depth of field and the displacement of the focus. The focal length, which can be shortened, has, in turn, the advantage that the welding speed can be markedly increased, and speeds of 4 to 6 m/minute and more can be reached depending on the type and the quality of the laser. Even higher speeds can be reached in case of a moving laser welding head with scanner optical system. Another advantage of the reduced focal length is the associated improvement of the beam quality, which in turn leads to improved quality of welding and increased welding speed.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a top schematic view showing a robot park with a plurality of stationary laser welding heads supplied by a common laser beam source and with component handling by means of robots;

FIG. 2 is a top schematic view showing a variant of the device according to FIG. 1 with a larger component handled by two robots in conjunction with a plurality of laser welding heads arranged in such a way that they have limited mobility;

FIG. 3 is a top schematic view showing a laser welding device with a laser welding head moved by means of a robot;

FIG. 4 is a top schematic view showing another laser welding device with a laser welding head moved by means of a robot; and

FIG. 5 is a top schematic view showing a manufacturing plant with a plurality of laser welding stations of different designs.

### DESCRIPTION OF THE PREFERRED EMBODIMENTS

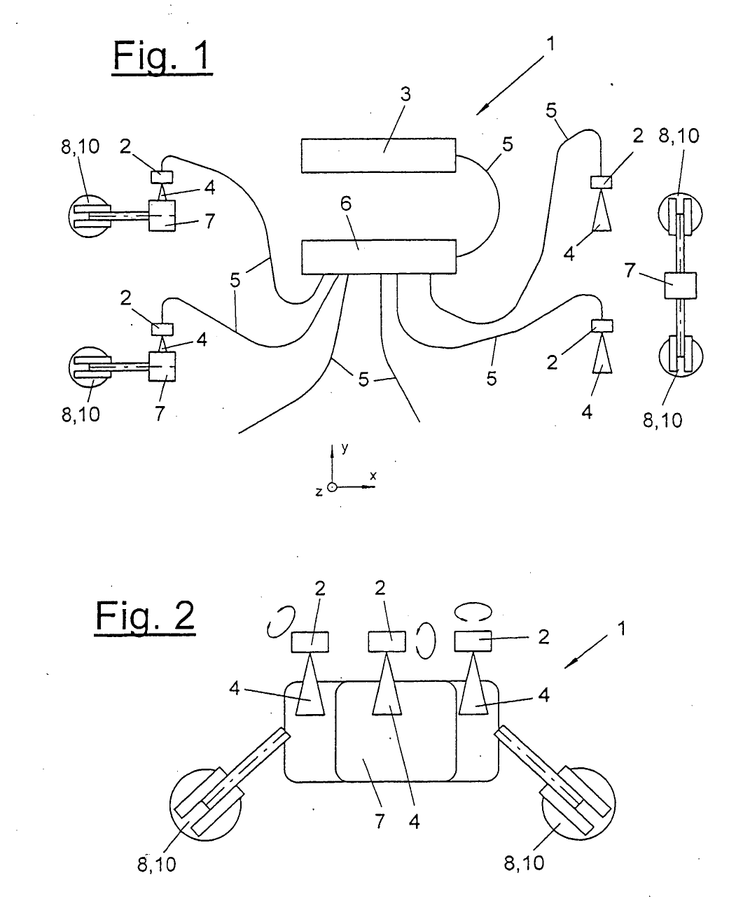

Referring to the drawings in particular, FIG. 1 shows a laser welding device (1) with at least one laser beam source (3), which is connected with a beam switch (6) by means of a laser beam guide (5), for example, an optical fiber cable. The laser beam coupled in is distributed by the beam switch (6) among a plurality of additional laser beam guides (5), which are connected with a laser welding head (2).

All the laser welding heads (2) are arranged stationarily in the exemplary embodiment according to FIG. 1. They are designed as remote laser heads, which are arranged at spaced locations from and without physical contact with the workpiece or component (7) and are held floatingly by a suitable stationary carrying means. The remote laser heads have a preferably multiaxially movable scanner optical system with scanner mirrors or the like, which permit the laser beam (4) to be deflected in different directions. The laser beam (4) can be moved very fast and precisely by the scanner optical system.

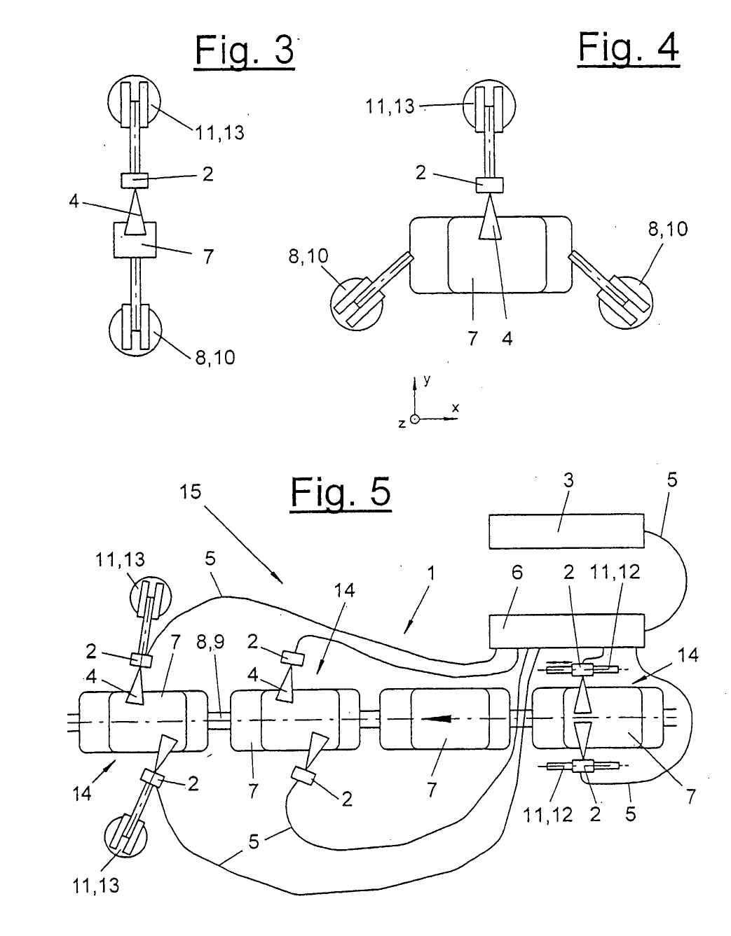

As an alternative, the scanner optical system may be eliminated, in which case the laser welding heads (2) emit a nonmoving laser beam (4). In another variant, it is possible to arrange the laser welding heads (2) stationarily, but to hold them in their position in a rotatably movable manner and to fasten them, e.g., to an articulated hand of a multiaxial articulated arm robot, as in the variant according to FIGS. 3 and 4, in which case an extension arm may be optionally intercalated. In case of a corresponding arrangement and orientation, the laser beam (4) can be moved by small and rapid axial movements of the multiaxial, e.g., three-axis robot hand of the otherwise stationary robot. The manual scanning movement may replace the scanner optical system.

The laser welding heads (2) preferably have a focal length between 200 mm and 400 mm. An especially favorable focal length equals, for example, 250 mm.

One or more components (7) are welded in the laser welding device (1) by the laser welding heads (2) with the moving laser beam (4). The components (7) are, for example, body parts of vehicles. The components (7) are guided and moved here in relation to the laser welding heads (2) arranged at spaced locations by means of suitable moving means (8) along a preset, programmed and preferably multiaxial movement path. The movement path may extend in space as desired and may have any desired curvature. The moving means (8) are multiaxial robots (10) in the exemplary embodiment being shown, which are preferably designed as six-axis articulated arm robots with rotatory axes. As an alternative, the robots (10) may have fewer or more axes, for example, additional linear or travel axes. Furthermore, the axes may be translatory axes or combinations of rotatory and translatory axes.

The components (7) are clamped in a standard gripper in the exemplary embodiment shown in FIG. 1. As an alternative, they may also be clamped in position with high precision in a so-called geo gripper. The robot (10) handles the gripper and the clamping means with the component and moves these relative to the stationary laser welding head (2) and the moving laser beam (4).

In the embodiment of the stationary laser welding heads (2) according to FIG. 1, the robots (10) perform the complete shifting movement of the components (7) with reorientation to the beginning of the seam and with subsequent movement along the path. This is advantageous above all in case of longer weld seams. The robots (10) are correspondingly programmed and controlled for this. The seam forms are preferably lap seams and fillet welds, and other seam forms, such as butt seams or the like, are also possible.

When the end of the particular seam being welded is reached on a component (7), the laser beam (4) can be switched over immediately by the beam switch (6) and assigned to another laser welding head (2) and the component (7) located there. The corresponding robot (10) has already positioned the component (7) in this case at the beginning of the seam to be welded. During the welding operation, the other robots (10) can re-orient and reposition a previously welded component (7) for welding the next seam. As an alternative, they may also perform another handling of the component, for example, a changing of the components, mounting and equipping the component (7) with additional small parts, etc.

If many short seams located one after another are to be welded, for example, flange seams in the side rail and rocker area, the use of monoaxial scanner optical systems is advantageous. These scanner optical systems deflect the laser beam (4) in one fixed direction only. The robot (10) preferably positions the component (7) with the direction that essentially corresponds to the monoaxial scanning movement. The shifting movement from one seam to the next is assumed by the scanner optical system. The changes in orientation and position are performed by the robot (10) and its component handling during the movement along the path. If sections in which the linear scanning area or the working space of the robot (10) requires a greater shifting movement or a greater change in orientation, the laser beam (4) is switched over in the above-mentioned manner to another laser welding head (2). Optimized occupation and utilization times are thus obtained for the laser beam source (3).

As an alternative, the scanner optical systems may have two or more axes. A Z compensation may take place in the direction of the beam in the third axis. The use of such scanner optical systems requires robot movements only when the scanning area is left and when changes in the orientation of the components (7) are necessary in a new scanning area. If no more welding movements are possible and the robot has been moving for a rather long time, the laser beam (4) is switched over to another ready-to-weld laser welding head (2) in this case as well. Optimal occupation and utilization times are obtained in this case as well.

FIG. 2 shows a variant of FIG. 1, in which a larger component (7), for example, a side panel or a complete body, is handled by two or more robots (10) that cooperate with one another. The laser welding device (1) has a plurality of essentially stationary laser welding heads (2) in this, preferably three, which may, however, have an additional movement axis, which is indicated by arrows in the drawing. These may be especially rotary and pivoting movements, with which the scanner optical systems, which are oriented with one or more axes here as well, make possible a larger working space.

The focal distance of the laser welding heads (2) can be adjusted by a corresponding movement of the component by the robots (10) in the embodiments shown in FIGS. 1 and 2. When the laser beam is deflected by the scanner optical system, the beam path to the point at which it meets the component (7) or the laser spot on the component (7) can be changed by the laser optical system. The laser spot can leave the focal point in laser welding heads (2) with fixed focal length, which may lead to an impairment of the quality of the beam and the quality of welding. This shift can be compensated by a corresponding movement of the component by means of robots (10), and the component (7) is always guided at the desired distance from the laser welding head (2) or the scanner optical system, which is optimal for the particular process step. The component (7) does not need to be held continuously in the focal point of the laser beam (4). As an alternative, it is possible to guide and hold the component (7) at a deliberately maintained distance in front of or behind the focal point in the direction of the beam in order to have certain welding options. For example, an enlargement of the laser spot, which is associated with the defocusing, may be desired to obtain a broader weld seam. However, the more accurately the component (7) is being held and guided in or at the focal point, the better is the coupling in of the laser beam at the component (7) and also the conversion of the energy and the quality of welding. The welding speed can also be correspondingly high in the direction of the path to be welded.

FIGS. 3 and 4 show another variant, in which the laser welding head (2) is not arranged stationarily any longer, but is moved by a suitable moving means (11), for example, a multiaxial welding robot (13). This robot (13) may have the same kinematics as the above-described handling robot (10) for the components (7). The component (7) is guided in the variant according to FIG. 3 by a single robot (10) in relation to a welding robot (13). In the variant according to FIG. 4, two cooperating robots (10) move a component (7) together in relation to one or more welding robots (13).

FIG. 5 schematically shows a complete manufacturing plant (15) with a plurality of laser welding stations (14), which are in turn supplied by one or more common laser beam sources (3) via beam switches (6) and laser beam guides (5).

A plurality of components (7), for example, tacked vehicle bodies, are transported in the manufacturing plant (15) by a linear component conveyor (9), for example, a cyclically transporting shuttle or a continuously transporting roller conveyor or the like in the direction of the arrow. Different welding tasks are performed in the different laser welding stations (14). For example, one or more laser welding heads (2) are arranged movably on a moving means (11) in the direction in which the component is moved on both sides of the component (7) in the first laser welding station (14), which is shown under the beam switch (6). The moving means (11) may be a linear conveyor (12) in this case. The laser welding heads (2) with their laser beams (4) are displaced now along the stationary or moving component (7). The laser welding heads (2) may have the above-described monoaxial or multiaxial scanner optical system.

Other machining operations or activities may be carried out on the component (7) in the next station. One or more laser welding heads (2), which are positioned stationarily in this case, are again preferably arranged on both sides of the component (7) in the next laser welding station (14). The relative movement between the laser welding head (2) or the laser beam (4) and the component (7) may also be generated by the component conveyor (9) in this case.

One or more welding robots (13) of the type shown in FIG. 3 are again arranged on both sides of the component (7) in the last laser welding station (14).

Various variants of the exemplary embodiments shown are possible. In particular, the features shown and described in the individual exemplary embodiments may be transposed and combined as described. Instead of the robots (10), one monoaxial or multiaxial moving means (8) may be present. The moving means (11) for the laser welding heads (2), which may likewise be designed as monoaxial or multiaxial units, for example, as cross slides with two translatory axes, are also variable. Moreover, the design of the laser welding heads (2) may also be varied as described; they may have a stationary focusing unit with an immobile laser beam (4) instead of a monoaxially or multiaxially movable scanner optical system in the simplest case. All relative movements between the laser beam (4) and the component (7) are generated by the handling of the component by means of the moving means (8) in this case. Furthermore, it is possible to provide other deflecting or guiding units for the laser beam (4) instead of the scanner optical systems equipped with one or more movable and controllable mirrors.

While specific embodiments of the invention have been shown and described in detail to illustrate the application of the principles of the invention, it will be understood that the invention may be embodied otherwise without departing from such principles.

1. A laser welding device for welding one or more components, the device comprising:
one or more said laser welding heads;
one or more moving means for said components for a relative movement of said components in relation to said laser welding head, said laser welding heads including a remote laser arranged at a spaced location from said component.

2. A laser welding device in accordance with claim 1, wherein said moving means comprises a component conveyor.

3. A laser welding device in accordance with claim 1, wherein said moving means comprises a multiaxial robot.

4. A laser welding device in accordance with claim 1, wherein said laser welding head is arranged stationarily.

5. A laser welding device in accordance with claim 1, wherein said laser welding head is arranged nonstationarily by means of a moving unit.

6. A laser welding device in accordance with claim 1, wherein said laser welding head has one or more scanner heads for the controllable deflection of said laser beam.

7. A laser welding device in accordance with claim 1, wherein said moving means for said components is controlled according to the focal distance.

8. A laser welding device in accordance with claim 1, wherein said laser welding head has a focal distance of approx. 200 mm to 400 mm.

9. A laser welding device in accordance with claim 1, wherein a plurality of said laser welding heads are connected to a said common external laser beam source by means of a said controllable beam switch and said laser beam guides.

10. A process for the laser welding of one or more components by means of one or more laser welding heads, the process comprising the steps of: guiding the components and during welding using one or more moving means for a multiaxial relative movement of the components in relation to said laser welding head, and providing the one or more welding heads with a remote laser arranged at a spaced location from the component.

11. A process for laser welding in accordance with claim 10, wherein said components are moved by one or more said multiaxial robots.

12. A laser welding device for welding components, the device comprising:
laser welding heads;
a moving means for providing a relative movement of each of said components in relation to one or more of said laser welding head; and
a laser beam source and laser beam transmission element, said laser beam source being at a remote location from said welding head and arranged at a spaced location from said component, said laser beam transmission element transmitting the laser beam to the welding head.

13. A laser welding device in accordance with claim 12 wherein said moving means comprises a component conveyor.

14. A laser welding device in accordance with claim 12, wherein said moving means comprises a multiaxial robot.

15. A laser welding device in accordance with claim 12, wherein said laser welding head is arranged stationarily.

16. A laser welding device in accordance with claim 12, wherein said laser welding head is arranged nonstationarily by means of a moving unit.

17. A laser welding device in accordance with claim 12, wherein said laser welding head has one or more scanner heads for the controllable deflection of said laser beam.

18. A laser welding device in accordance with claim 12, wherein said moving means for said components is controlled according to the focal distance of the welding head.

19. A laser welding device in accordance with claim 12, wherein said laser welding head has a focal distance of approx. 200 mm to 400 mm.

20. A laser welding device in accordance with claim 19, wherein said laser beam transmission element is a plurality of said laser welding heads are connected to said laser beam source as a common external laser beam source by a controllable beam switch and via laser beam guides.
